(19) United States
(12) Patent Application Publication
(10) Pub. No.: US 2025/0372962 A1
(43) Pub. Date: Dec. 4, 2025

(54) COMPACT DUAL FEEDERS AND METHODS TO CONNECT FIELD CONNECTIONS TO DUAL FEEDERS IN MOTOR CONTROL CENTERS (MCCS)

(71) Applicant: Eaton Intelligent Power Limited, Dublin 4 (IE)

(72) Inventors: Shriram Jayshankar Ghorpade, Fayetteville, NC (US); John A. Bordewick, Fayetteville, NC (US); Deepak Ramhari Shinde, Nashik (IN); Darryl K. Ripley, Fayetteville, NC (US)

(21) Appl. No.: 19/223,347

(22) Filed: May 30, 2025

(30) Foreign Application Priority Data
May 31, 2024 (IN) 202411042370

(51) Int. Cl. H02B 1/36; H02B 1/21

(52) U.S. Cl. CPC H02B 1/36; H02B 1/21

(57) ABSTRACT

A connection system for use with a motor control unit is provided. The connection system includes one or more physical channels for passage of wires or cables that connect one or more motor control units to a common bus that distributes electrical power to the one or more motor control units. The one or more channels include a plurality of channels; the plurality of channels are provided in a single housing; and the plurality of channels are molded into the single housing such that the connection system is one contiguous piece. Related connectors are also provided.

### CROSS-REFERENCE TO RELATED APPLICATION

This application claims priority to and the benefit of Indian Provisional Patent Application No. 202411042370, filed May 31, 2024, the content of which is hereby incorporated herein by reference in its entirety.

### FIELD

The present inventive concept relates generally to motor control centers (MCCs) and, more particularly, connecting to customer cables.

### BACKGROUND

A motor control center (MCC) is a multi-compartment steel enclosure with a bus system to distribute electrical power from a common bus to a plurality of individual motor control units mountable within the compartments. The individual motor control center units are commonly referred to as “buckets” and are typically constructed to be removable modular units that have, or are installed behind, individual sealed doors on the motor control center enclosure. These units may contain various motor control and motor protection devices such as motor controllers, starters, contactor assemblies, overload relays, circuit breakers, motor circuit protectors, various disconnects, and similar devices for electric motors. The units connect to the common power bus of the motor control center and conduct supply power to a line side of the motor control devices for operation of motors and feeder circuits. Motor control centers are often used in factories and industrial facilities that utilize high power electrical motors, pumps, and other loads.

In particular, MCCs can include cabinets or enclosures that hold multiple, typically modular, bucket assemblies or units of various sizes. Such configurations are discussed in, for example, U.S. Pat. No. 4,024,441, the contents of which are hereby incorporated by reference as if recited in full herein. Furthermore, U.S. Pat. No. 8,934,218 discusses an MCC having compact bucket assemblies that conveniently plug into a slot or space in an MCC cabinet, the contents of which are hereby incorporated by reference as if recited in full herein. Although the compact bucket assemblies are smaller, thereby allowing more units to be installed, the compact dual feeder system is difficult to connect to customer wires due to the compact space, for example, only 6 inches of height. Accordingly, improved connection methods are desired.

### SUMMARY

Some embodiments of the present inventive concept provide a connection system for use with a motor control unit. The connection system includes one or more physical channels for passage of wires or cables that connect one or more motor control units to a common bus that distributes electrical power to the one or more motor control units.

In further embodiments, the one or more channels may include a plurality of channels; the plurality of channels may be provided in a single housing; and the plurality of channels may be molded into the single housing such that the connection system is one contiguous piece.

In still further embodiments, the single housing may include one or more lug alignment components that facilitate alignment of the connection system with one or more lugs associated with the one or more motor control units. The one or more lug alignment components may physically push the lugs associated with the one or more motor control units into the one or more motor control units causing the one or more lugs to be flush and parallel inside the one or more motor control units.

In some embodiments, the single housing may further include one or more key points on a side surface of the housing, the key points being configured to lock into slots on the one or more motor control units to maintain stability of the connection system.

In further embodiments, the housing may include polylactic acid (PLA) or molded glass reinforced, black polyphenylene oxide.

In still further embodiments, the one or more motor control units may include one or more of motor controllers, starters, contactor assemblies, overload relays, circuit breakers, motor circuit protectors and various disconnects.

In some embodiments, the one or more motor control units may be received by a motor control center (MCC). The MCC is a multicompartment enclosure coupled to the common bus that distributes electrical power from the common bus to the one or more motor control units.

In further embodiments, the one or more motor control units may connect to the common bus of the MCC and supply power to a line side of the one or more motor control units.

In still further embodiments, the one or more physical channels may include one or more slip tubes that provide for the passage of wires or cables that connect the one or more motor control units to the common bus that distributes electrical power to the one or more motor control units.

In some embodiments, the one or more slip tubes may include a plurality of interlocked slip tubes connected to a gas barrier and sealed with a corresponding grommet.

In further embodiments, the plurality of slip tubes may each have a square plate on one end thereof, the square plates keying into the gas barrier to secure the tubes in place.

In still further embodiments, the plurality of interlocked slip tubes may include a non-conductive, rigidly, flexible material.

In some embodiments, the one or more motor control units may be received by a motor control center (MCC) and are connected to the common bus of the MCC using a stab finger.

Further embodiments of the present inventive concept provide an integral connector for use with a circuit breaker. The integral connector includes a housing defining a plurality of channels for passage of wires or cables that connect one or more circuit breakers to a common bus that distributes electrical power to the one or more circuit breakers; one or more lug alignment components on the housing that facilitate alignment of the connector with one or more lugs associated with the one or more circuit breakers; and one or more key points on a side surface of the housing, the key points being configured to lock into slots on the one or more circuit breakers to maintain stability of the connector.

In still further embodiments, the one or more lug alignment components may physically push the lugs associated with the one or more circuit breaker into the one or more circuit breakers causing the one or more lugs to be flush and parallel inside the one or more circuit breaker.

In some embodiments, the one or more circuit breakers may include two circuit breakers in a single unit, wherein both circuit breakers connect to the common bus using a common stab finger.

In further embodiments, two circuit breakers may be provided in a single six inch space.

In still further embodiments, the housing may include polylactic acid (PLA) or molded glass reinforced, black polyphenylene oxide.

### BRIEF DESCRIPTION OF THE DRAWINGS

FIG. 1A is diagram illustrating a motor control center (MCC) including twelve feeders.

FIG. 1B is a diagram illustrating an MCC including twenty-four feeders in accordance with some embodiments of the present inventive concept.

FIGS. 2A and 2B are diagrams including a connection system in accordance with some embodiments of the present inventive concept.

FIG. 3A is a diagram illustrating slip tubes in accordance with some embodiments of the present inventive concept.

FIG. 3B is a diagram illustrating slip tubes connected in a bucket in accordance with some embodiments of the present inventive concept.

FIG. 4 is a diagram illustrating slip tubes having plates and coupled to a gas barrier in accordance with some embodiments of the present inventive concept.

FIG. 5 is a diagram illustrating a gas barrier in accordance with some embodiments of the present inventive concept.

FIG. 6 is a diagram illustrating a grommet in accordance with some embodiments of the present inventive concept.

FIGS. 7A and 7B are diagrams illustrating labels indicating which slip tubes access which feeder in accordance with some embodiments of the present inventive concept.

FIG. 8 is a diagram illustrating lug nuts with gas barrier removed in accordance with some embodiments of the present inventive concept.

FIG. 9 is a diagram illustrating a grommet and insertion thereof in accordance with some embodiments of the present inventive concept.

FIGS. 10A and 10B are diagrams illustrating front and back perspective views, respectively, of a single piece connector in accordance with some embodiments of the present inventive concept.

FIG. 11 is a diagram illustrating an inside of a bucket showing the single piece connector in accordance with some embodiments of the present inventive concept.

FIG. 12 is a diagram illustrating a perspective view of a bucket including lug alignment components in accordance with some embodiments of the present inventive concept.

FIG. 13 is a diagram illustrating a bracket used to install the connector in accordance with some embodiments of the present inventive concept.

FIG. 14 is a diagram illustrating stab fingers in accordance with some embodiments of the present inventive concept.

### DETAILED DESCRIPTION OF EMBODIMENTS

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

As discussed above, U.S. Pat. No. 8,934,218 discusses a motor control center (MCC) having compact bucket assemblies that conveniently plug into a slot or space in, for example, an MCC cabinet. Although smaller, thereby allowing more units to be installed, the compact dual feeder system may be difficult to connect to customer wires due to the compact space, for example, only six (6) inches of height. Accordingly, some embodiments of the present inventive concept provide a connection system that allows easier installation of compact dual feeder systems. In some embodiments, one or more slip tubes are provided that enable simpler connections in view of the smaller form factor. In further embodiments, a single piece unit having one or more tunnels therethrough enable wires to be easily coupled in the small space. Thus, embodiments of the present inventive concept provide a simpler, unique, low cost and relatively easy to implement solution to problems discussed above as will be discussed further herein with respect to the figures.

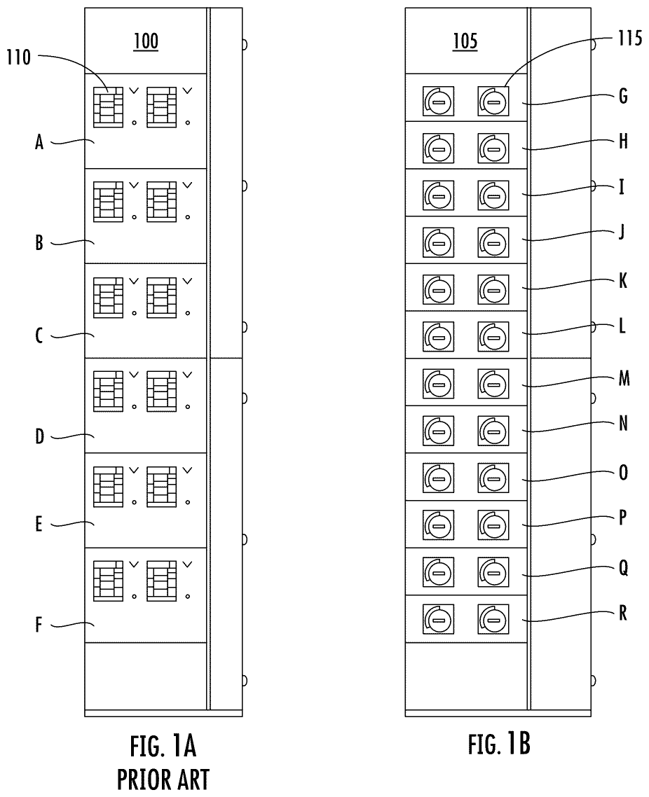

Typically, a motor control center (MCC) is configured with an array of buckets (units), structure, or column composed of starter units for supplying electrical motors and pumps and also composed of general feeder units for supplying feeder circuits. The starter units may include a number of other motor control components. A conventional MCC 100 is shown in FIG. 1A and includes six dual feeders 110 per section A, B, C, D, E and F, allowing a total of twelve (12) feeders in the MCC 100, 100 A per CB. FIG. 1B illustrates an MCC 105 in accordance with some embodiments of the present inventive concept. As shown, the compact offering in accordance with embodiments discussed herein may include twelve (12) feeders 115 per section G, H, I, J, K, L, M, N, O, P, Q and R, for a total of twenty-four (24) feeders, 60 A per CB (60 percent of conventional). Thus, embodiments of the present inventive concept allow for an increase in capacity in a same space and using the same/similar form factor. However, this increase in density may create a problem with accessibility, i.e. it is difficult to connect the customer cables, especially on the left side of the MCC.

In particular, embodiments of the present inventive concept provide a new compact offering with dual feeder having, for example, a 1 (i.e. 6.0 inch) bucket height with a rotary handle mechanism. In some embodiments, a bucket height (X) may be equal to 6 inches. Thus, 1× indicates 6 inches, 2× indicates 12 inches . . . 12× indicates 72 inches. As shown in FIG. 1B, with the new form factor, twenty-four (24) feeders may be provided in the same space as the 12 in the configuration illustrated in FIG. 1A. However, providing more feeders in the same space may present problems when wiring customer connections and verifying that the load is correctly connected with the feeder. In other words, with the new more compact form factor, when the bucket is installed in the MCC structure, it is difficult to see the lugs of a feeder on the interior side and connect customer field wiring to, for example, a left-hand side feeder. It may also be difficult to verify that the load connection is safe to operate.

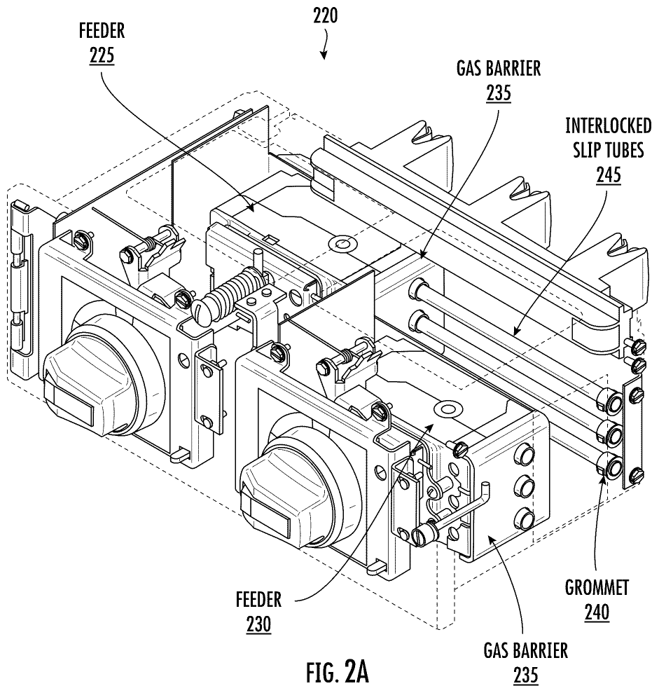

Accordingly, to address the sight and connection difficulty in the compact form factor in accordance with embodiments illustrated in FIG. 1B, embodiments of the present inventive concept provide a system that makes connections easier and simplifies the verification that the connection is safe to proceed. Referring now to FIGS. 2A and 2B, an MCC 105 including the connection system in accordance with some embodiments of the present inventive concept will be discussed. As illustrated in FIG. 2A, a bucket 220 including two feeders 225 and 230, for example, a left hand feeder and right hand feeder, respectively, and a connecting system. The connecting system includes a plurality of interlocked tubes 245, a gas barrier 235 and a plurality of grommets 240. It will be understood that although FIG. 2A illustrates two feeders, three tubes and three grommets, embodiments of the present inventive concept are not limited thereto. Two or less or more than three tubes may be present without departing from the scope of the present inventive concept. An alternate bottom view of an open bucket 220 is shown in FIG. 2B having the left feeder 225 hidden, which further illustrates the plurality of connection tubes 245 connected to the gas barrier 235.

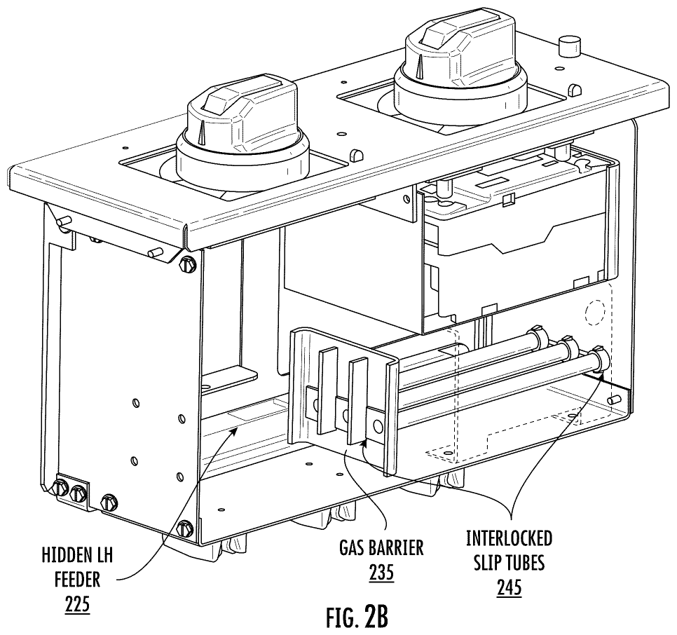

The two feeders 225 and 230 are illustrated are a left-hand and right-hand feeder, respectively, however, the feeders are not limited thereto. Any type of feeder may be provided without departing from the scope of the present inventive concept. The plurality of interlocked tubes 245 (slip tubes) are provided as long channels 245 as shown in FIG. 3A. In some embodiments, these slip tubes are made of a dielectric and rigidly flexible material. In some embodiments, the slip tube 245 is made of a non-conductive, rigidly, flexible material, for example, a carbon fiber. As further illustrated, the slip tubes 245 have a square plate 250 on one end thereof as illustrated in FIGS. 3A and 3B that keys into the gas barrier 235 to keep the tubes in place. In some embodiments, the slip tubes 245 are a single piece part and are dropped-off from the gas barrier 235. The slip tubes 245 and gas barrier 235 are assembled to the load side of the feeder as shown in FIG. 2A. Thus, the slip tube 245 is mounted in between a load side of the feeder and gas barrier 235. As further illustrated in FIG. 2A, one end of the slip tube 245 is mounted to the gas barrier 235 and the other side is accessible from outside the housing of the feeder and has circular grommet 240 attached thereto.

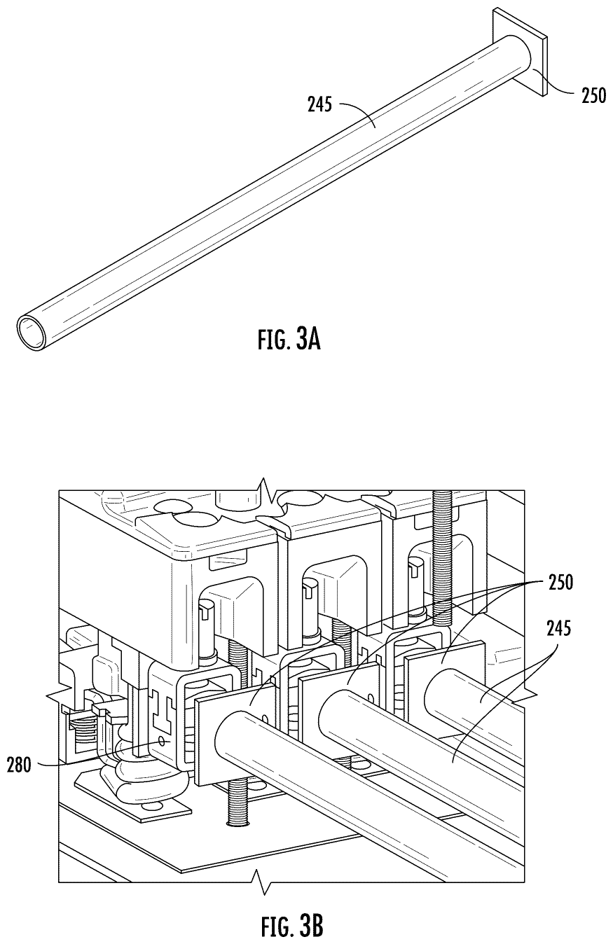

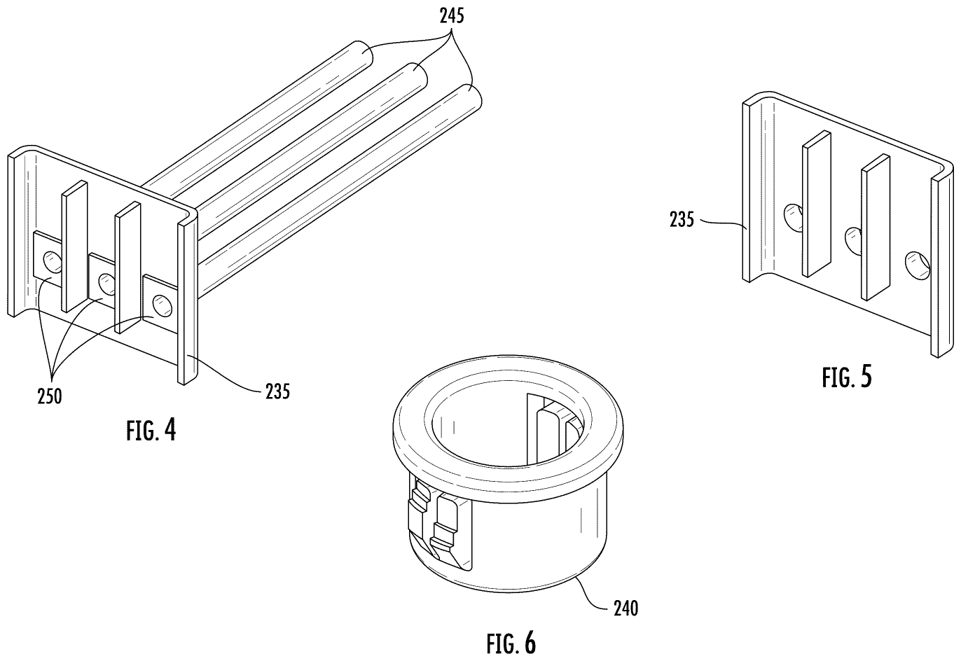

FIG. 4 illustrates the slip tubes 245 having square plates 250 on ends thereof and connected to the gas barrier 235 that holds the slip tubes 245 in place. FIG. 5 illustrates a gas barrier 235 in accordance with some embodiments of the present inventive concept. It will be understood that the elements in FIGS. 4 and 5 are provided as examples and embodiments of the present inventive concept may differ.

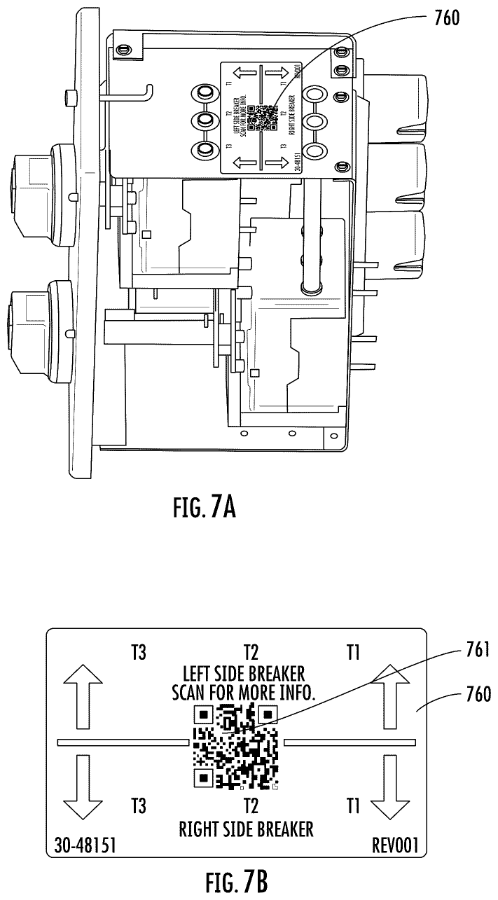

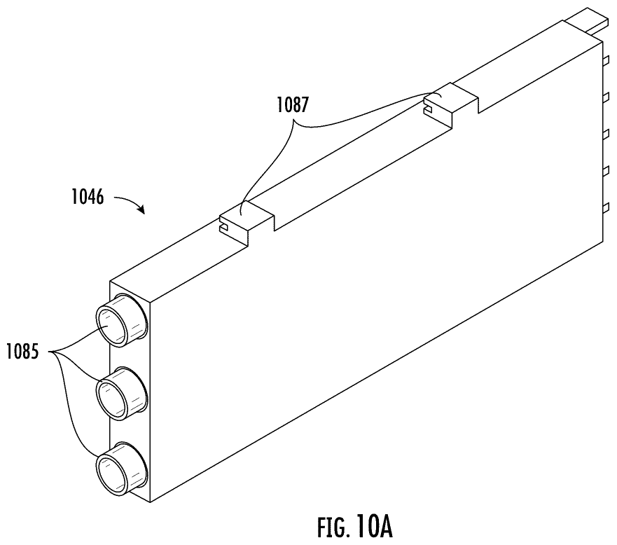

The grommets 240 function to keep the slip tubes 245 in straight line with little distortion. In other words, any distortion that is present does not interfere with the function of the slip tubes 245. The grommets 240 may clip/press into an end of the slip tubes 245 from outside into a slot/space 990 (FIG. 9) between the slip tube 245 and the housing as shown in FIG. 9. An example grommet 240 that may be used in accordance with some embodiment of the present inventive concept is illustrated in FIG. 6. However, it will be understood that embodiments of the present inventive concept are not limited to this configuration. Other form factors for the grommet may be used without departing from the scope of the present inventive concept.

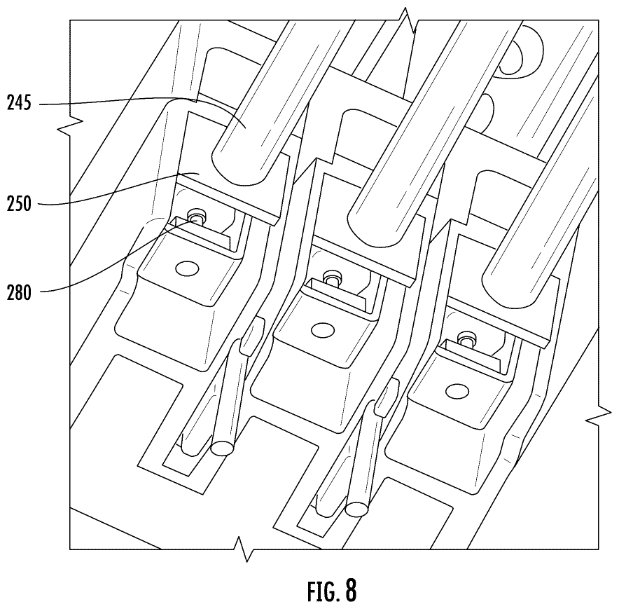

In operation, when a compact, for example, 6-inch, bucket is inserted into the MCC 220 in accordance with some embodiments discussed herein, a customer can open the wireway and locate the left-hand (LH) side feeder 225 and the right-hand (RH) side feeder field connection cables. As illustrated in FIGS. 7A and 7B, labels 760 provided on the housing allow the user to determine which of the plurality of slip tubes 245 provide access to which feeder, i.e. the label 760 indicates what connection points can be accessed through each of the plurality of slip tubes 245. As further illustrated, in some embodiments, the label 760 may include a QR code 761 that links to installation literature in case a user misplaces the paperwork that comes with the feeder/breaker. Use of the QR code 761 also allows a user to access the most up to date information about the system as the source can be updated frequently. This information may include, for example, the proper torque needed to install a feeder, length of wires necessary and the like.

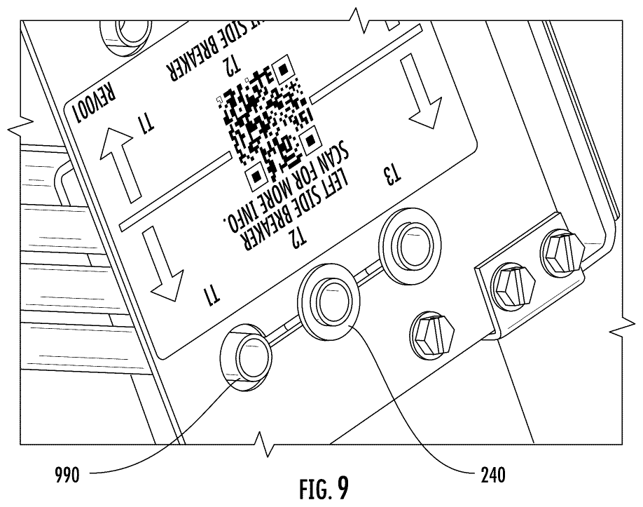

Referring again to FIG. 2, cables used to connect the feeders are inserted through the grommets 240 and then through the plurality of slip tubes 245 to connect the LH feeder 225. Thus, the connections system discussed herein simplifies access to the LH feeder 225. These customer connections can be performed from, for example, a 4-inch wireway, so the user/customer bends the cable first and then slides the cable into the appropriate slip tube 245. The design of slip tube 245 allows this bend accommodation and still extends to the lugs 280 on feeder. When the cable connects with the lugs on the feeder, the user may hear an audible click/tactile feel and the user may then rotate/move (torque) the cable to complete the connection. FIG. 8 illustrates the slip tubes 245 connected to the plates 250 and the lugs 280. The gas barrier has been hidden in FIG. 8 to illustrate the lugs 280 on the feeder that make contact with the cable when inserted through the slip tubes 245. FIG. 2B illustrates these connections by hiding the left-side feeder. However, it will be understood that other connection methods may be used without departing from the scope of the present inventive concept.

In some embodiments, the customer cables may be marked with a distance, for example, a distance of 6-8 inches, after which it will get connected inside the lugs of feeder on the load side. Then the user can access front holes on feeder to tighten the cables and apply specified torque according to a specific rating that may be provided on the label 760 of accessed using the QR code 761 discussed above.

As discussed briefly herein, some embodiments of the present inventive concept provide a connection system including a plurality of slip tubes that enables easier access to connection points on a feeder in a compact environment. Thus, embodiments of the present inventive concept may provide a reduction in arcing events in case of faults due to incorrect lug connections. Furthermore, the ability to provide secure connections in this compact environment allows provision of a compact offering (dual feeder in 6 inch height) and slip tube design which ensures load side cables are safely/firmly connected. Furthermore, in some embodiments discussed herein, a size of the buckets were reduced from 3×, i.e. 18 inches to 2×, i.e. 12 inches, saving a valuable 1×, i.e. 6 inch space in the MCC structure.

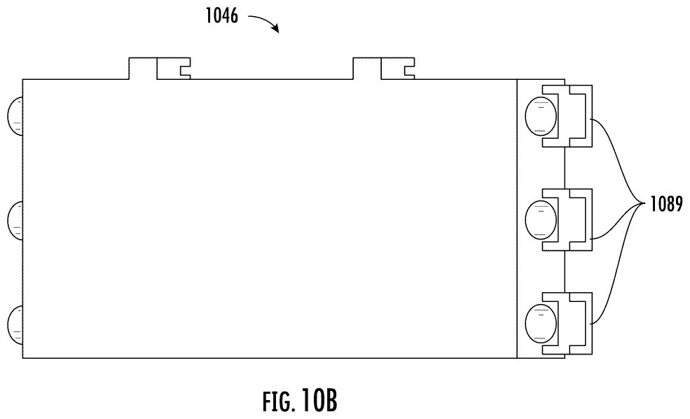

Referring now to FIGS. 10A through 14, further embodiments of the present inventive concept will be discussed. Embodiments discussed above with respect to FIGS. 1 through 9 provide one or more slip tubes used to access connections to a left hand feeder to due space limitations. Having a plurality of individual one slip tubes may introduce some challenges, for example, with assembly and/or holding the tubes in place. Accordingly, embodiments discussed below with respect to FIGS. 10A through 14 provide a connection system including a single, one piece housing having one or more channels therein. The channels in the housing provide access to the cabling of the left hand feeder similar to the access provided by the plurality of slip tubes discussed above. Details with respect to the single piece embodiment will be discussed below with respect to the figures.

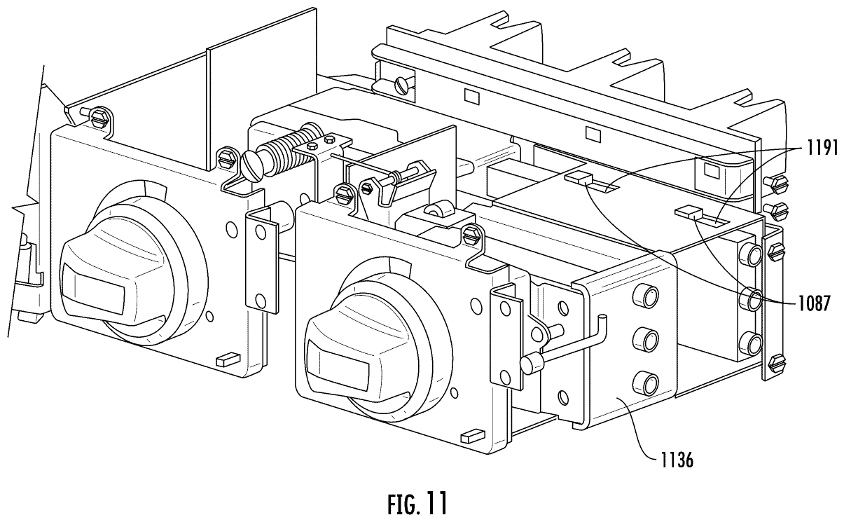

Referring first to FIGS. 10A and 10B, diagrams illustrating front and back perspective views, respectively, of a single piece connector in accordance with some embodiments of the present inventive concept will be discussed. As illustrated in FIGS. 10A and 10B, a single piece connector 1046 is provided having a plurality of channels 1085 therein that provide access to the feeder on the interior of the MCC. FIG. 10A further illustrates two key points 1087 on one side of the connection 1046. These key points facilitate locking the connector 1046 into place in the feeder as shown, for example, in FIG. 11. As illustrated therein, the two key points 1087 on the connector 1046 slide into slots 1191 and snap in. In other words, the slots 1191 are wider at the point where the key points 1087 are inserted and then the slots 1191 get narrower so that the key points 1087 lock in when they are positioned in the narrower area of the slots 1191.

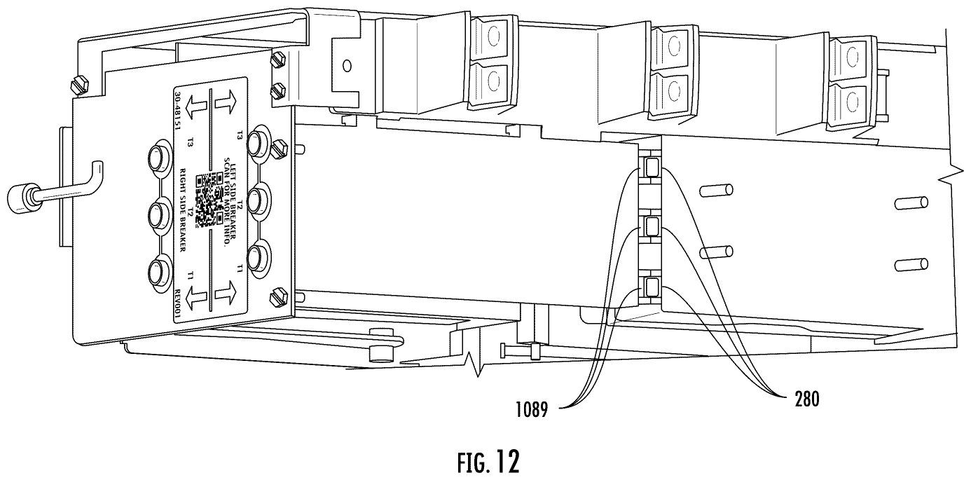

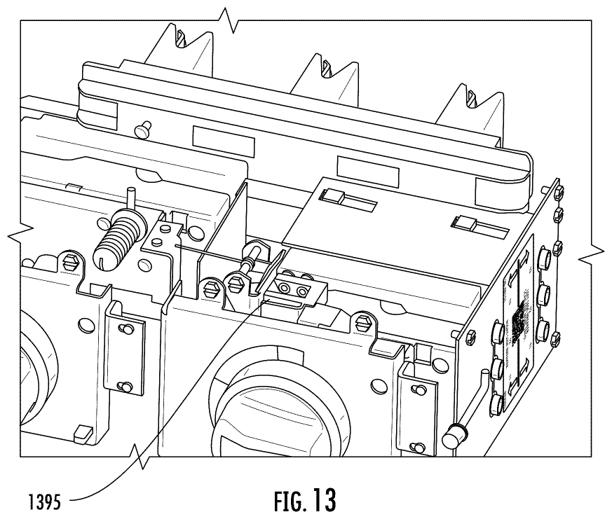

As further illustrated in FIG. 10B, the connector 1046 has a plurality of lug alignment components 1089 corresponding to each channel 1085. These lug alignment components 1089 on one end of the connector 1046 facilitate the connectors alignment with the lugs 280 as shown in, for example, FIG. 12. These lug alignment components 1089 actually push the lugs into the feeder/breaker, thereby, allowing the cables/wires to be easily fastened into the lug with screws. These lugs alignment features cause the lugs 280 to be flush and parallel inside the breaker. Thus, there is no problem getting the wires directly into the lugs when inserted through the channels of the connector. In some embodiments, a bracket 1395 shown in FIG. 13 is provided to further lock the connector into place. Although embodiments illustrated herein are illustrated as having three channels, two alignment components and two key points, embodiments are not limited to this configuration. More or less than each feature provided may be provided without departing from the scope of the present inventive concept.

As further illustrated in FIG. 11, a gas barrier 1136 may be provided and covers the ends of the channels. It will be understood that embodiments of the present inventive concept illustrated in FIGS. 10A through 13 do not include a grommet on the end of the channels as discussed above with respect to FIGS. 1-9.

The connector 1046 in accordance with embodiment illustrated in FIGS. 10A through 13, may be made of any suitable material. For example, in some embodiments, the connector may include polylactic acid (PLA) or may be the same material as the gas barrier 1136. For example, the gas barrier may include molded glass reinforced, black polyphenylene oxide. PLA is a thermoplastic monomer derived from renewable, organic sources such as corn starch or sugar cane. In some embodiments, elements of the connector system may be 3D printed; however, embodiments are not limited thereto. It will be understood that these materials are provided as examples only and embodiments are not limited thereto. Any suitable material may be used without departing from the scope of the present inventive concept.

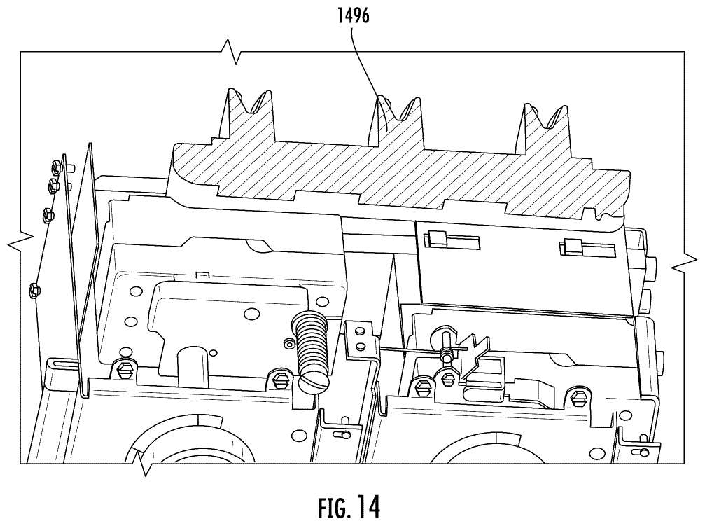

As illustrated in FIG. 14, both feeders/circuit breakers are connected to a common “stab finger” 1496 (vertical bus bar retractable termination). The stab finger 1496 connects to a vertical bus to both units. Thus, embodiments discussed herein provide two units (two breakers), which are two separate circuits and two separate loads. There are two wires per stab finger, one wire connects to phase A of breaker 1 and one wire connects to phase A of breaker 2. Thus, a customer is provided with two circuit breaker load options in a small 6 inch space.

As discussed briefly herein, some embodiments of the present inventive concept provide a connection system including a one piece connector having channels therein that enable easier access to connection points on a feeder in a compact environment. The one piece connector included lug alignment features and key points that makes installation easier and more secure and eliminates the need for grommets. Thus, embodiments of the present inventive concept may provide a reduction in arcing events in case of faults due to incorrect lug connections. Furthermore, the ability to provide secure connections in this compact environment allows provision of a compact offering (dual feeder in 6 inch height) and slip tube design which ensures load side cables are safely/firmly connected. Furthermore, in some embodiments discussed herein, a size of the buckets were reduced from 3×, i.e. 18 inches to 2×, i.e. 12 inches, saving a valuable 1×, i.e. 6 inch space in the MCC structure.

In the drawings and specification, there have been disclosed example embodiments of the inventive subject matter. Although specific terms are employed, they are used in a generic and descriptive sense only and not for purposes of limitation, the scope of the inventive subject matter being defined by the following claims

What is claimed is:

1. A connection system for use with a motor control unit, the connection system comprising:
one or more physical channels for passage of wires or cables that connect one or more motor control units to a common bus that distributes electrical power to the one or more motor control units.

2. The connection system of claim 1:
wherein the one or more channels comprise a plurality of channels;
wherein the plurality of channels are provided in a single housing; and
wherein the plurality of channels are molded into the single housing such that the connection system is one contiguous piece.

3. The connection system of claim 2, wherein the single housing further comprises one or more lug alignment components that facilitate alignment of the connection system with one or more lugs associated with the one or more motor control units.

4. The connection system of claim 3, wherein the one or more lug alignment components physically push the lugs associated with the one or more motor control units into the one or more motor control units causing the one or more lugs to be flush and parallel inside the one or more motor control units.

5. The connection system of claim 2, wherein the single housing further comprises one or more key points on a side surface of the housing, the key points being configured to lock into slots on the one or more motor control units to maintain stability of the connection system.

6. The connection system of claim 2, wherein the housing comprises polylactic acid (PLA) or molded glass reinforced, black polyphenylene oxide.

7. The connection system of claim 1, wherein the one or more motor control units comprise one or more of motor controllers, starters, contactor assemblies, overload relays, circuit breakers, motor circuit protectors and various disconnects.

8. The connection system of claim 1:
wherein the one or more motor control units are received by a motor control center (MCC); and
wherein the MCC is a multicompartment enclosure coupled to the common bus that distributes electrical power from the common bus to the one or more motor control units.

9. The connection system of claim 8, wherein the one or more motor control units connect to the common bus of the MCC and supply power to a line side of the one or more motor control units.

10. The connection system of claim 1, wherein the one or more physical channels comprise one or more slip tubes that provide for the passage of wires or cables that connect the one or more motor control units to the common bus that distributes electrical power to the one or more motor control units.

11. The connection system of claim 10, wherein the one or more slip tubes comprise a plurality of interlocked slip tubes connected to a gas barrier and sealed with a corresponding grommet.

12. The connection system of claim 11, wherein the plurality of slip tubes each have a square plate on one end thereof, the square plates keying into the gas barrier to secure the tubes in place.

13. The connection system of claim 11, wherein the plurality of interlocked slip tubes comprise a non-conductive, rigidly, flexible material.

14. The connection system of claim 1, wherein the one or more motor control units are received by a motor control center (MCC) and are connected to the common bus of the MCC using a stab finger.

15. An integral connector for use with a circuit breaker, the integral connector comprising:
a housing defining a plurality of channels for passage of wires or cables that connect one or more circuit breakers to a common bus that distributes electrical power to the one or more circuit breakers;
one or more lug alignment components on the housing that facilitate alignment of the connector with one or more lugs associated with the one or more circuit breakers; and
one or more key points on a side surface of the housing, the key points being configured to lock into slots on the one or more circuit breakers to maintain stability of the connector.

16. The connector of claim 15, wherein the one or more lug alignment components physically push the lugs associated with the one or more circuit breaker into the one or more circuit breakers causing the one or more lugs to be flush and parallel inside the one or more circuit breaker.

17. The connector of claim 16, wherein the one or more circuit breakers comprise two circuit breakers in a single unit, wherein both circuit breakers connect to the common bus using a common stab finger.

18. The connector of claim 17, wherein two circuit breakers are provided in a single six inch space.

19. The connector of claim 15, wherein housing comprises polylactic acid (PLA) or molded glass reinforced, black polyphenylene oxide.
